(19) United States
(12) Patent Application Publication
(10) Pub. No.: US 2006/0188748 A1
(43) Pub. Date: Aug. 24, 2006

(54) Cemented carbide insert for wear resistance demanding short hole drilling operations

(75) Inventors: Jan Kjellgren, Kista (SE); Rickard Sundstrom, Alta (SE); Torbjorn Agren, Falun (SE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB

(21) Appl. No.: 11/343,201

(22) Filed: Jan. 31, 2006

(30) Foreign Application Priority Data
Jan. 31, 2005 (SE) 0500235-7

(51) Int. Cl. B05D 1/36; B32B 9/00; B32B 19/00

(52) U.S. Cl. 428/698; 428/701; 428/702; 427/402; 427/419.2; 427/419.7

(57) ABSTRACT

Coated cemented carbide inserts for short hole drilling in steel at high speed and moderate feed is disclosed. The cemented carbide includes WC, about 2-10 wt-% Co, and about 4-12 wt-% cubic carbides of metals from groups IVa, Va or VIa. The Co-binder phase is highly alloyed with W with a CW-ratio of about 0.75-0.90. The insert has a binder phase enriched and essentially cubic carbide free surface zone of a thickness of less than about 20 μm. Along a line essentially bisecting the edge in the direction from the edge to the centre of the insert, a binder phase content increases essentially monotonously until it reaches the bulk composition. Binder phase content at the edge in vol-% is about 0.65-0.75 times binder phase content of the bulk. The depth of the binder phase depletion is about 100-300 μm.

### BACKGROUND OF THE INVENTION

The present invention relates to a coated cutting tool insert particularly useful for short hole drilling in steel at high speed and moderate feed.

Drilling in metals is divided generally in two types: long hole drilling and short hole drilling. By short hole drilling is meant generally drilling to a depth of up to 3-5 times the drill diameter.

Long hole drilling puts large demands on good chip formation, lubrication, cooling and chip transport. This is achieved through specially developed drilling systems with specially designed drilling heads fastened to a drill rod and fulfilling the above mentioned demands.

In short hole drilling, the demands are not as great, enabling the use of simple helix drills formed either of solid cemented carbide or as solid tool steel or of tool steel provided with a number of cutting inserts of cemented carbide placed in such a way that they together form the necessary cutting edge. In the center of the head an insert of tough grade is used and on the periphery a more wear resistant one. The cutting inserts are brazed or mechanically clamped.

U.S. Pat. No. 5,786,069 and U.S. Pat. No. 5,863,640 disclose coated cutting tool inserts with a binder phase enriched surface zone and a highly W-alloyed binder phase.

### OBJECTS AND SUMMARY OF THE INVENTION

It is an object of the invention is to provide a coated cutting tool insert with ability to perform at higher speeds, maintaining a good balance, regarding tool life, between periphery and center inserts.

In one aspect of the invention, there is provided a cutting tool insert comprising a cemented carbide body and a coating

the cemented carbide body comprising WC with an average grain size of from about 1.0 to about 4.0 μm, from about 4 to about 7 wt-% Co and from about 7 to about 10 wt-% of cubic carbides of metals from groups IVa, Va or VIa of the periodic table whereby N is added in an amount of from about 1.1 to about 1.4% of the weight of the elements from groups IVa and Va

the Co-binder phase is highly alloyed with W with a CW-ratio of from about 0.75 to about 0.90

the cemented carbide body has a binder phase enriched and cubic carbide free surface zone A of a thickness of from about 5 to about 15 μm

the cemented carbide body has along a line C, bisecting the edge, in the direction from edge to the centre of the insert, a binder phase content increasing monotonously until it reaches the bulk composition from a binder phase content in vol-% at the edge of from about 0.65 to about 0.75 times the binder phase content of the bulk whereby the depth of the binder phase depletion is from about 100 to about 300 μm and the coating comprises

a first innermost layer of TiCₓN_{y}O_{z} with x+y+z=1 with a thickness of from about 0.1 to about 2 μm, and with equiaxed or columnar grains with size less than about 0.5 μm

a next layer of TiCₓN_{y}O_{z} x+y+z=1 with a thickness of from about 4 to about 7 μm with columnar grains and with a diameter of less than about 5 μm, preferably less than about 2

a next layer of TiCₓN_{y}O_{z,} x+y+z=1 with z being less than or equal to about 0.5 with a thickness of from about 0.1 to about 2 μm and with equiaxed or needlelike grains with size less than or equal to about 0.5 μm, this layer being the same as or different from the innermost layer, and

an outer layer of a smooth, textured, fine-grained, (grain size about 1 μm) α-Al₂O₃ layer with a thickness of from about 3 to about 6 μm and a surface roughness (Rₐ) of less than 0.3 μm over a measured length of 0.25 mm.

In another aspect of the invention, there is provided a method of making a cutting insert comprising a cemented carbide substrate with a binder phase enriched surface zone and a coating, said substrate comprising a binder phase of Co, WC and a cubic carbonitride phase, said binder phase enriched surface zone being free of said cubic carbonitride phase and with an constant thickness around the insert, said method comprising forming a powder mixture containing WC, from about 4 to about 7 weight percent Co and from about 7 to about 10 weight percent cubic carbides of the metals from groups IVa, Va or VIa of the periodic table whereby N is added in an amount of between about 1.1 and about 1.4 of the weight of the elements from groups IVa and Va,

mixing said powders with a pressing agent and possibly W such that the desired CW-ratio of from about 0.75 to about 0.90 is obtained,

milling and spray drying the mixture to a powder material with the desired properties,

compacting and sintering the powder material at a temperature of from about 1300 to about 1500° C., in a controlled atmosphere of about 5 kPa followed by cooling,

applying conventional post sintering treatments including edge rounding and

applying a hard, wear resistant coating comprising

a first innermost layer of TiCₓN_{y}O_{z} with x+y+z=1 with a thickness of from about 0.1 to about 2 μm, and with equiaxed or columnar grains with size less than about 0.5 μm using known CVD-methods

a next layer of TiCₓN_{y}O_{z} x+y+z=1 with a thickness of from about 2 to about 10 μm with columnar grains and with a diameter of less than about 5 μm deposited either by MTCVD-technique using acetonitrile as the carbon and nitrogen source for forming the layer in the temperature range of from about 700 to about 900° C. or by high temperature CVD-technique, from about 1000 to about 1100° C., the process conditions being selected to grow layers with columnar grains, that is generally high process pressure of from about 0.3 to about 1 bar

a next layer of TiCₓN_{y}O_{z}, x+y+z=1 with z being less than or equal to about 0.5 with a thickness of from about 0.1 to about 2 μm and with equiaxed or needlelike grains with size less than or equal to about 0.5 μm, using known CVD-methods, this layer being the same as or different from the innermost layer

an outer layer of a smooth textured α-Al₂O₃ layer with a thickness of from about 2 to about 10 μm and a surface roughness (Rₐ) of less than 0.3 μm over a measured length of 0.25 mm.

### BRIEF DESCRIPTION OF THE FIGURE

FIG. 1 is a schematic drawing of a cross section of an edge of an insert gradient sintered according to the present invention where

A=binder phase enriched surface zone

B=cutting edge near zone

C=a line essentially bisecting the edge.

### DETAILED DESCRIPTION OF THE PREFERRED EMBODIMENTS OF THE INVENTION

Significant improvements with respect to resistance to plastic deformation and toughness behavior can simultaneously be obtained for a cemented carbide insert if a number of features are combined. The improvement in cutting performance of the cemented carbide inserts can be obtained if the cobalt binder phase is highly alloyed with W, if the essentially cubic carbide free and binder phase enriched surface zone A has a certain thickness and composition, if the cubic carbide composition near the cutting edge B is optimized and if the insert is coated with about 3 to about 12 μm columnar Ti(C,N)-layer followed by about 2 to about 12 μm thick Al₂O₃-layer e.g. produced according to any of the patents U.S. Pat. No. 5,766,782, U.S. Pat. No. 5,654,035, U.S. Pat. No. 5,674,564 or U.S. Pat. No. 5,702,808 possibly with an outermost layer of from about 0.5 to about 4 μm TiN. The Al₂O₃-layer serves as an effective thermal barrier during cutting and thereby improves not only the resistance to plastic deformation which is a heat influenced property but also increase the crater wear resistance of the cemented carbide insert. In addition, if the coating along the cutting edge is smoothed by an appropriate technique like by brushing with a SiC-based nylon brush or by a gentle blasting with Al₂O₃ grains the cutting performance can be enhanced further, in particular with respect to flaking resistance of the coating (see U.S. Pat. No. 5,861,210).

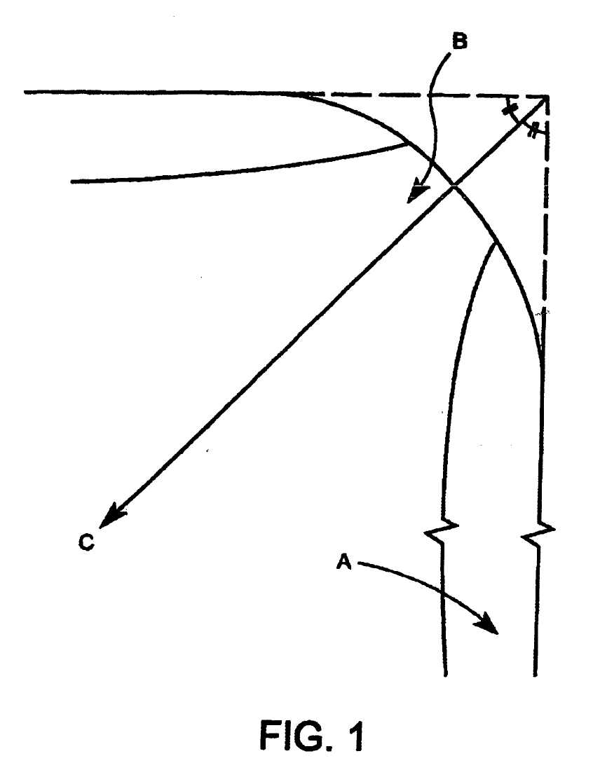

According to the present invention, there is now provided a coated cemented carbide insert with less than about 20 μm, preferably from about 5 to about 15 μm, thick essentially cubic carbide free and binder phase enriched surface zone A (FIG. 1) with an average binder phase content (by volume) of from about 1.2 to about 3.0 times the bulk binder phase content. In order to obtain high resistance to plastic deformation but simultaneously avoid a brittle cutting edge, the chemical composition is optimized in zone B (FIG. 1). Along line C (FIG. 1), in the direction from edge to the center of the insert, the binder phase content increases essentially monotonously until it reaches the bulk composition. At the edge the binder phase content in vol-% is from about 0.65 to about 0.75, preferably about 0.7 times the binder phase content of the bulk. In a similar way, the cubic carbide phase content decreases along line C from about 1.3 times the content of the bulk. The depth of the binder phase depletion and cubic carbide enrichment along line C is from about 100 to about 300 μm, preferably from about 150 to about 250 μm.

The binder phase is highly W-alloyed. The content of W in the binder phase can be expressed as a

CW-ratio=Mₛ/(wt-% Co·0.0161) where

Mₛ is the saturation magnetization of the cemented carbide body in hAm²/kg and wt-% Co is the weight percentage of Co in the cemented carbide. The CW-ratio takes a value ≦1 and the lower the CW-ratio is the higher is the W-content in the binder phase. It has now been found according to the invention that an improved cutting performance is achieved if the CW-ratio is from about 0.75 to about 0.90, preferably from about 0.80 to about 0.85. Alternatively, the amount of W dissolved in the binder phase can be determined by use of a specific device which can read a specific magnetic saturation such as the Sigmameter of Setaram Instrumentation.

The present invention is applicable to cemented carbides with a composition of from about 4 to about 7 weight percent of binder phase of Co, and from about 7 to about 10 weight percent cubic carbides of the metals from groups IVa, Va or VIa of the periodic table, preferably greater than about 1 wt % of each of Ti, Ta and Nb, balance WC. The WC has an average grain size of from about 1.0 to about 4.0 μm, preferably from about 2.0 to about 3.0 μm. The cemented carbide body may contain small amounts, less than about 1 volume-%, of η-phase (M₆C).

The coating comprises

a first (innermost) layer of TiCₓN_{y}O_{z} with x+y+z=1, preferably z is less than about 0.5, with a thickness of from about 0.1 to about 2 μm, and with equiaxed or columnar grains with size less than about 0.5 μm

a next layer of TiCₓN_{y}O_{z} with x+y+z=1, preferably with z=0 and x being greater than about 0.3 and y being greater than about 0.3, with a thickness of from about 4 to about 7 μm with columnar grains and with a diameter of less than about 5 μm, preferably less than about 2 μm

a next layer of TiCₓN_{y}O_{z}, x+y+z=1 with z being equal to or less than about 0.5, preferably z being greater than about 0.1, with a thickness from about 0.1 to about 2 μm and with equiaxed or needle-like grains with size being less than or equal to about 0.5 μm, this layer being the same as or different from the innermost layer

an outer layer of a smooth, textured, fine-grained (grain size about 1 μm) α-Al₂O₃ layer with a thickness from about 3 to about 6 μm and a surface roughness (Rₐ) of less than 0.3 mm over a measured length of 0.25 mm, and

possibly an outermost layer from about 0.5 to about 4 μm TiN.

In addition, the α-Al₂O₃ layer has a preferred crystal growth orientation in either the (012)-, (104)- or (110)-direction, preferably in the (012)-direction, as determined by X-ray Diffraction (XRD) measurements. A Texture Coefficient, TC, is defined as:

$$TC ( hkl ) = \frac{I ( hkl )}{{I}_{o} ( hkl )} {\{ \frac{1}{n} \sum \frac{I ( hkl )}{{I}_{o} ( hkl )} \}}^{- 1}$$

Where

I(hkl)=measured intensity of the (hkl) reflection

I_{O}(hkl)=standard intensity of the ASTM standard powder

pattern diffraction data

n=number of reflections used in the calculation, (hkl)

reflections used are: (012), (104), (110), (113), (024), (116)

According to the invention TC for the set of (012), (104) or (110) crystal planes is larger than about 1.3, preferably larger than about 1.5.

The invention also relates to a method of making cutting inserts comprising a cemented carbide substrate consisting of a binder phase of Co, WC and a cubic carbonitride phase with a binder phase enriched surface zone essentially free of cubic phase and a coating. The powder mixture contains from about 2 to about 10, preferably from about 4 to about 7, weight percent of binder phase comprising Co, and from about 4 to about 12, preferably from about 7 to about 10, weight percent cubic carbides of the metals from groups IVa, Va or VIa of the periodic table, preferably greater than about 1 wt % of each Ti, Ta and Nb and a balance WC with an average grain size of from about 1.0 to about 4.0 μm, preferably from about 2.0 to about 3.0 μm. Well-controlled amounts of nitrogen are added either through the powder as carbonitrides or/and added during the sintering process via the sintering gas atmosphere. The amount of added nitrogen will determine the rate of dissolution of the cubic phases during the sintering process and hence determine the overall distribution of the elements in the cemented carbide after solidification. The optimum amount of nitrogen to be added depends on the composition of the cemented carbide and in particular on the amount of cubic phases and varies between about 0.9 and about 1.7%, preferably from about 1.1 to about 1.4%, of the weight of the elements from groups IVa and Va of the periodic table. The exact conditions depend to a certain extent on the design of the sintering equipment being used. It is within the purview of the skilled artisan to determine whether the requisite surface zones A and B of cemented carbide have been obtained and to modify the nitrogen addition and the sintering process in accordance with the present specification in order to obtain the desired result.

The raw materials are mixed with pressing agent and possibly W such that the desired CW-ratio is obtained and the mixture is milled and spray dried to obtain a powder material with the desired properties. Next, the powder material is compacted and sintered. Sintering is performed at a temperature of from about 1300 to about 1500° C., in a controlled atmosphere of about 5 kPa followed by cooling. After conventional post sintering treatments including edge rounding a hard, wear resistant coating according to above is applied by CVD- or MT-CVD-technique.

According to method of the invention a WC—Co-based substrate is coated with

a first (innermost) layer of TiCₓN_{y}O_{z} with x+y+z=1, preferably z is less than about 0.5, with a thickness of from about 0.1 to about 2 μm, and with equiaxed or columnar grains with size less than about 0.5 μm using known CVD-methods.

a next layer of TiCₓN_{y}O_{z} with x+y+z=1, preferably with z=0 and x being greater than about 0.3 and y being greater tyhan about 0.3, with a thickness of from about 2 to about 10 μm, preferably from about 4 to about 7 μm, with columnar grains and with a diameter of about less than about 5 μm, preferably less than about 2 μm, deposited either by MTCVD-technique (using acetonitrile as the carbon and nitrogen source for forming the layer in the temperature range of from about 700 to about 900° C.) or by high temperature CVD-technique (from about 1000 to about 1100 C), the process conditions being selected to grow layers with columnar grains, that is generally high process pressure (from about 0.3 to about 1 bar). However, the exact conditions depend to a certain extent on the design of the equipment used.

a next layer of TiCₓN_{y}O_{z}, x+y+z=1 with z being less than or equal to about 0.5, preferably z being greater than about 0.1, with a thickness of from about 0.1 to about 2 μm and with equiaxed or needlelike grains with size being less than or equal to about 0.5 μm, using known CVD-methods this layer being the same as or different from the innermost layer.

an outer layer of a smooth textured α-Al₂O₃ layer with a thickness of from about 2 to about 10 μm, preferably from about 3 to about 6 μm, and a surface roughness (Rₐ) of less than about 0.3 μm over a measured length of 0.25 mm according to U.S. Pat. No. 5,487,625, U.S. Pat. No. 5,851,687 and U.S. Pat. No. 5,766,782.

When a TiCₓN_{y}O_{z}-layer with z>0 is desired, CO₂ and/or CO is added to the reaction gas mixture.

The invention is additionally illustrated in connection with the following examples, which are to be considered as illustrative of the present invention. It should be understood, however, that the invention is not limited to the specific details of the examples.

### EXAMPLE 1

A.) Cemented carbide drilling inserts of the style CoroDrill880, US0807P-GM, with the composition 5.5 wt % Co, 3.5 wt % TaC, 2.3 wt % NbC, 2.1 wt % TiC and 0.4 wt % TiN and balance WC with an average grain size of 2.5 μm were produced according to the invention. The nitrogen was added to the carbide powder as Ti(C,N). Sintering was done at 1450° C. in a controlled atmosphere consisting of Ar, CO and some N₂ at a total pressure of about 5 kPa.

Metallographic investigation showed that the produced cemented carbide inserts had a cubic-carbide-free zone A with a thickness of 10 μm. Image analysis technique was used to determine the phase composition at zone B and the area along line C (FIG. 1). The measurements were done on polished cross sections of the inserts over an area of about 40×40 μm gradually moving along the line C. The phase composition was determined as volume fractions. The analysis showed that the cobalt content in zone B was 0.7 times the bulk cobalt content and the cubic carbide content 1.3 times the bulk cubic carbide content. The measurements of the bulk content were also done by image analysis technique. The Co-content was gradually increasing and the cubic carbide content gradually decreasing along line C in the direction from the edge to the centre of the insert.

Magnetic saturation values were recorded and used for calculating CW-values. An average CW-value of 0.84 was obtained.

The inserts were coated with a 0.5 μm equiaxed Ti(C,N)-layer followed by a 5 μm thick Ti(C,N) layer with columnar grains by using MTCVD-technique (process temperature 850° C.). In subsequent process steps during the same coating cycle, a 1 μm thick layer with equiaxed grains of TiCₓN_{y}O_{z} (approx. x=0.6, y=0.2 and z=0.2) was deposited followed by a 4 μm thick layer of (012)-textured α-Al₂O₃ deposited according to conditions given in Swedish patent 501 527. XRD-measurement showed a texture coefficient TC(012) of 1.5. After coating the inserts were smoothed by wet blasting.

### EXAMPLE 2

Inserts from Example 1 were tested and compared with inserts from Sandvik commercial grade 3040 with respect to wear resistance in a short hole drilling operation. The tested inserts were mechanically clamped on the periphery of the drill head. In the center, an insert of tough grade was used according to Example 1 of patent application No filed concurrently herewith (Attorney Docket No. 47113.5017, herein incorporated by reference in its entirety). Tool life criteria: flank wear, crater wear or chipping >0.25 mm.

| | |
|---|---|
| Material: | Low alloy steel SS2541-03, 285 HB. |
| Emulsion: | Blasocut BC25, 7%. |
| Operation: | Through hole, 48 mm. |
| Cutting speed: | 260 m/min |
| Feed: | 0.10 mm/r |
| Drill: | Diameter 24 mm, 3 × D |
| Insert style: | CoroDrill 880, US0807P-GM |
| Results. Drilled length at tool life: | |
| Inserts according to the invention | >15 meters |
| Reference inserts | 5 meters |

### EXAMPLE 3

Inserts from Example 1 were tested and compared with inserts from Sandvik commercial grade 304.0 with respect to wear resistance in a short hole drilling operation. The tested inserts were mechanically clamped on the periphery of the drill head. In the center, an insert of tough grade was used according to Example 1 of patent application No filed concurrently herewith (Attorney Docket No. 47113.5017). Tool life criteria: flank wear, crater wear or chipping >0.25 mm.

| | |
|---|---|
| Material: | Low alloy steel SS2541-03, 285 HB. |
| Emulsion: | Blasocut BC25, 7%. |
| Operation: | Through hole, 48 mm. |
| Cutting speed: | 230 m/min |
| Feed: | 0.20 mm/r |
| Drill: | Diameter 24 mm, 3 × D |
| Insert style: | CoroDrill 880, US0807P-GM |
| Results. Drilled length at tool life: | |
| Inserts according to the invention | 6 meters |
| Reference inserts | 8.4 meters |

### EXAMPLE 4

Inserts from Example 1 were tested and compared with inserts from Sandvik commercial grade 3040 with respect to wear resistance in a short hole drilling operation. The tested inserts were mechanically clamped on the periphery of the drill head. In the center, an insert of tough grade was used according to Example 1 of patent application No filed concurrently herewith (Attorney Docket No. 47113.5017). Tool life criteria: flank wear, crater wear or chipping >0.25 mm.

| | |
|---|---|
| Material: | Low alloy steel SS2541-03, |
| | 330-340 HB. |
| Emulsion: | Blasocut BC25, 7%. |
| Operation: | Through hole, 48 mm. |
| Cutting speed: | 260 m/min |
| Feed: | 0.10 mm/r |
| Drill: | Diameter 23 mm, 3 × D |
| Insert style: | CoroDrill 880, US0807P-GM |
| Results. Drilled length at tool life: | |
| Inserts according to the invention | 15.4 meters |
| Reference inserts | 7 meters |

### EXAMPLE 5

Inserts from Example 1 were tested and compared with inserts from Sandvik commercial grade 4025 with respect to wear resistance in a short hole drilling operation. The tested inserts were mechanically clamped on the periphery of the drill head. In the center, an insert of tough grade was used according to Example 1 of patent application No filed concurrently herewith (Attorney Docket No. 47113.5017). Tool life criteria: flank wear, crater wear or chipping >0.25 mm.

| | |
|---|---|
| Material: | Low alloy steel SS2541-03, 400 HB. |
| Coolant: | Cooledge 5, 50 bar. |
| Operation: | Through hole, 30 mm. |
| Cutting speed: | 300 m/min |
| Feed: | 0.10 mm/r |
| Drill: | Diameter 24 mm, 2 × D |
| Insert style: | CoroDrill 880, US0807P-GM |
| Results. Drilled length at tool life: | |
| Inserts according to the invention | 8.5 meters |
| Reference inserts | 5.3 meters |

### EXAMPLE 6

Inserts from Example 1 were tested and compared with inserts from Sandvik commercial grade 3040 with respect to wear resistance in a short hole drilling operation. The tested inserts were mechanically clamped on the periphery of the drill head. In the center, an insert of tough grade was used according to Example 1 of patent application No filed concurrently herewith (Attorney Docket No. 47113.5017). Tool life criteria: flank wear, crater wear or chipping >0.25 mm.

| | |
|---|---|
| Material: | Low alloy steel SS2541-03, 285 HB |
| Emulsion: | Syntilo XPS, 7%. |
| Operation: | Through hole, 40 mm. |
| Cutting speed: | 350 m/min |
| Feed: | 0.12 mm/r |
| Drill: | Diameter 16.5 mm, 3 × D |
| Insert style: | CoroDrill 880, US0602P-GM |
| Results. Drilled length at tool life: | |
| Inserts invention | 7.5 meters |
| Inserts reference | 3.5 meters |

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. A cutting tool insert comprising a cemented carbide body and a coating
the cemented carbide body comprising WC with an average grain size of from about 1.0 to about 4.0 μm, from about 4 to about 7 wt-% Co and from about 7 to about 10 wt-% of cubic carbides of metals from groups IVa, Va or VIa of the periodic table whereby N is added in an amount of from about 1.1 to about 1.4% of the weight of the elements from groups IVa and Va
the Co-binder phase is highly alloyed with W with a CW-ratio of from about 0.75 to about 0.90
the cemented carbide body has a binder phase enriched and cubic carbide free surface zone A of a thickness of from about 5 to about 15 μm
the cemented carbide body has along a line C, bisecting the edge, in the direction from edge to the centre of the insert, a binder phase content increasing monotonously until it reaches the bulk composition from a binder phase content in vol-% at the edge of from about 0.65 to about 0.75 times the binder phase content of the bulk whereby the depth of the binder phase depletion is from about 100 to about 300 μm and the coating comprises
a first innermost layer of TiCₓN_{y}O_{z} with x+y+z=1 with a thickness of from about 0.1 to about 2 μm, and with equiaxed or columnar grains with size less than about 0.5 μm
a next layer of TiCₓN_{y}O_{z} x+y+z=1 with a thickness of from about 4 to about 7 μm with columnar grains and with a diameter of less than about 5 μm,
a next layer of TiCₓN_{y}O_{z}, x+y+z=1 with z being less than or equal to about 0.5 with a thickness of from about 0.1 to about 2 μm and with equiaxed or needlelike grains with size less than or equal to about 0.5 μm, this layer being the same as or different from the innermost layer, and
an outer layer of a smooth, textured, fine-grained, (grain size about 1 μm) α-Al₂O₃ layer with a thickness of from about 3 to about 6 μm and a surface roughness (Rₐ) of less than 0.3 μm over a measured length of 0.25 mm.

2. A cutting tool insert of claim 1 wherein the α-Al₂O₃ layer has a preferred crystal growth orientation in either the (012)-, (104)- or (110)-direction as determined by X-ray Diffraction (XRD) measurements whereby TC for the set of (012), (104) or (110) crystal planes is larger than about 1.3, TC being defined as:
$$TC ( hkl ) = \frac{I ( hkl )}{{I}_{o} ( hkl )} {\{ \frac{1}{n} \sum \frac{I ( hkl )}{{I}_{o} ( hkl )} \}}^{- 1}$$
where
I(hkl)=measured intensity of the (hkl) reflection
I_{O}(hkl)=standard intensity of the ASTM standard powder pattern diffraction data
n=number of reflections used in the calculation, (hkl) reflections used are: (012), (104), (110), (113), (024), (116).

3. A cutting tool insert of claim 1 including an outermost layer of from about 0.5 to about 4 μm TiN.

4. A cutting tool insert of claim 1 wherein the cutting edge is smoothed by brushing or by blasting.

5. A cutting tool insert of claim 1 wherein the average WC-grain size is from about 2.0 to about 3.0 μm.

6. A cutting tool insert of claim 1 wherein the cemented carbide body contains greater than about 1% of each Ti, Ta and Nb.

7. A cutting tool of claim 1 wherein the binder phase content in vol-% at the edge is 0.7 times the binder phase content of the bulk.

8. A cutting tool insert of claim 1 wherein the depth of the binder phase depletion is from about 150 to about 250 μm.

9. A cutting tool insert of claim 1 wherein in said first innermost layer, z is less than about 0.5.

10. A cutting tool insert of claim 1 wherein in said next layer after said first innermost layer, z=0, x is greater than about 0.3 and y is greater than about 0.3.

11. A cutting tool insert of claim 1 wherein in said next layer outer of said first next layer, z is greater than about 0.1.

12. A cutting tool insert of claim 2 wherein said α-Al₂O₃ layer has a preferred crystal growth orientation in the (012) direction.

13. A method of making a cutting insert comprising a cemented carbide substrate with a binder phase enriched surface zone and a coating, said substrate comprising a binder phase of Co, WC and a cubic carbonitride phase, said binder phase enriched surface zone being free of said cubic carbonitride phase and with an constant thickness around the insert, said method comprising forming a powder mixture containing WC, from about 4 to about 7 weight percent Co and from about 7 to about 10 weight percent cubic carbides of the metals from groups IVa, Va or VIa of the periodic table whereby N is added in an amount of between about 1.1 and about 1.4 of the weight of the elements from groups IVa and Va,
mixing said powders with a pressing agent and possibly W such that the desired CW-ratio of from about 0.75 to about 0.90 is obtained,
milling and spray drying the mixture to a powder material with the desired properties,
compacting and sintering the powder material at a temperature of from about 1300 to about 1500° C., in a controlled atmosphere of about 5 kPa followed by cooling,
applying conventional post sintering treatments including edge rounding and
applying a hard, wear resistant coating comprising
a first innermost layer of TiCₓN_{y}O_{z} with x+y+z=1 with a thickness of from about 0.1 to about 2 μm, and with equiaxed or columnar grains with size less than about 0.5 μm using known CVD-methods
a next layer of TiCₓN_{y}O_{z} x+y+z=1 with a thickness of from about 2 to about 10 μm with columnar grains and with a diameter of less than-about 5 μm deposited either by MTCVD-technique using acetonitrile as the carbon and nitrogen source for forming the layer in the temperature range of from about 700 to about 900° C. or by high temperature CVD-technique, from about 1000 to about 1100° C., the process conditions being selected to grow layers with columnar grains, that is generally high process pressure of from about 0.3 to about 1 bar
a next layer of TiCₓN_{y}O_{z}, x+y+z=1 with z being less than or equal to about 0.5 with a thickness of from about 0.1 to about 2 μm and with equiaxed or needlelike grains with size less than or equal to about 0.5 μm, using known CVD-methods, this layer being the same as or different from the innermost layer
an outer layer of a smooth textured α-Al₂O₃ layer with a thickness of from about 2 to about 10 μm and a surface roughness (Rₐ) of less than 0.3 μm over a measured length of 0.25 mm.

14. Method of claim 13 wherein said substrate contains greater than about 1% of each of Ti, Ta and Nb.

15. A method of claim 13 wherein in said first innermost layer, z is less than about 0.5.

16. A method of claim 13 wherein in said next layer after said first innermost layer, z=0, x is greater than about 0.3 and y is greater than about 0.3.

17. A method of claim 13 wherein in said next layer outer of said first next layer, z is greater than about 0.1.

18. A method of claim 13 wherein said α-Al₂O₃ layer has a preferred crystal growth orientation in the (012) direction.

19. A method of claim 13 wherein said first next layer has a thickness of from about 4 to about 7 μm.

20. A method of claim 13 wherein said outer layer has a thickness of from about 3 to about 6 μm.
